(19) United States
(12) Patent Application Publication
(10) Pub. No.: US 2010/0230123 A1
(43) Pub. Date: Sep. 16, 2010

(54) ARRANGEMENT FOR SETTING VARIABLE OPERATING ELEVATION OF A COMBINATION TURBO GARDEN TILLER AND GRASS TRIMMER APPARATUS

(76) Inventor: GEORGE A. ORTIZ, La Mirada, CA (US)

Correspondence Address: BORTON PETRINI, LLP, 5060 CALIFORNIA AVENUE, 7th FLOOR, BAKERSFIELD, CA, 93309, US

(21) Appl. No.: 12/402,080

(22) Filed: Mar. 11, 2009

(51) Int. Cl. A01B 33/00

(52) U.S. Cl. 172/41

(57) ABSTRACT

An arrangement for setting variable operating elevation for a hand-held powered tool capable of generating a rotational motion and employed to manipulate a combination turbo garden tiller and a grass trimmer apparatus includes at least one elongated rod like member engageable at a first end thereof with threaded end of the apparatus and engageable at an opposed second end thereof with the powered tool. The at least one elongated rod like member has each of a predetermined length and a third predetermined cross-sectional shape in a direction transverse to the predetermined length. At least one aperture is formed through the at least one elongated rod like member in the direction transverse to the predetermined length. An elongated pin is provided and has at least one end thereof sized for insertion into the at least one aperture.

### CROSS-REFERENCE TO RELATED APPLICATIONS

This application is closely related to U.S. Utility patent application Ser. No. 11/653,821 filed on Jan. 16, 2007 and entitled “Combination Garden Tiller and Sprinkler Head Grass Trimmer”. Disclosure of U.S. Ser. No. 11/653,821 is incorporated into this document by reference thereto.

### FIELD OF THE INVENTION

The present invention relates, in general, to lawn and garden type devices and, more particularly, this invention relates to an arrangement for setting variable operating elevation for a hand-held powered tool employed to manipulate a combination turbo garden tiller and a grass trimmer apparatus.

### BACKGROUND OF THE INVENTION

As is generally well known, when using lawn and garden tools that are capable of performing several tasks, a need arises to manipulate such tools at different elevations relative to the ground surface. Of a particular relevance is a combination garden tiller and sprinkler head grass trimmer apparatus. Generally, the apparatus is designed to be manipulated by a powered tool, for example such as a portable drill. Furthermore, for planting purposes it may be desirable to position such powered drill in close proximity to the apparatus and to the ground surface, while for general tilling purposes or trimming grass around sprinkler heads it may be desirable to elevate the powered drill at a greater distance from the ground surface or such sprinkler head so that the user may remain in generally upright position. It is also desired to simply and conveniently change the operating elevation of such tools in order to perform a specific task.

Therefore, there is a need for an arrangement for setting variable operating elevation for a power tool employed to manipulate a combination garden tiller and sprinkler head grass trimmer apparatus.

### SUMMARY OF THE INVENTION

The invention provides an apparatus an apparatus for at least one of trimming grass from around a head portion of a lawn water sprinkler and at least one of tilling, weeding and cultivating a small garden area. The apparatus has an elongated generally hollow tubular member closed at a first end thereof and at least one of a plurality of serrations and a predetermined number of tine members disposed at least one of on and adjacent to a second axially opposed end of the elongated generally hollow member. There is means attachable to the first closed end of the elongated generally hollow tubular member for setting operating elevation for a hand-held powered tool capable of generating rotational motion for manipulation of the apparatus. The operating elevation setting means includes at least one elongated rod like member having each of a predetermined length and a predetermined cross-sectional shape in a direction transverse to the predetermined length and a threaded portion disposed in at least one end of the at least one elongated rod like member coaxially with a longitudinal axis thereof. There is also means for removing torque applied by the powered tool to at least a portion of the operating elevation setting means during the manipulation of the apparatus. The torque removing means includes an aperture formed through the at least one elongated rod like member in the direction transverse to the predetermined length thereof and an elongated pin having at least one end thereof sized for insertion into the aperture

### OBJECTS OF THE INVENTION

It is, therefore, one of the primary objects of the present invention to provide an arrangement for setting variable operating elevation for a hand-held powered tool employed to manipulate a combination garden tiller and sprinkler head grass trimmer apparatus.

Another object of the present invention is to provide an arrangement for setting variable operating elevation for a hand-held powered tool employed to manipulate a combination garden tiller and sprinkler head grass trimmer apparatus that is economical to manufacture.

Yet another object of the present invention is to provide an arrangement for setting variable operating elevation for a hand-held powered tool employed to manipulate a combination garden tiller and sprinkler head grass trimmer apparatus that is simple to use.

A further object of the present invention is to provide an arrangement for setting variable operating elevation for a hand-held powered tool employed to manipulate a combination garden tiller and sprinkler head grass trimmer apparatus that employs threaded connections between various elongated sections.

Another object of the present invention is to provide an arrangement for setting variable operating elevation for a hand-held powered tool employed to manipulate a combination garden tiller and sprinkler head grass trimmer apparatus that employs means for remove effects of torque generated by the rotating powered tool.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a cross-sectional elevation view of a prior art apparatus for at least one of trimming grass from around a head portion of a lawn water sprinkler and at least one of tilling, weeding and cultivating a small garden area;

FIG. 2 is an exploded isometric view of an arrangement for setting variable operating elevation of the apparatus of FIG. 1;

FIG. 3 is a partial isometric view of the arrangement of FIG. 2, particularly illustrating one alternative embodiment of the present invention;

FIG. 4 is an end view of the arrangement of FIG. 2, particularly illustrating another alternative embodiment of the present invention; and

FIG. 5 is an end view of the arrangement of FIG. 2, particularly illustrating yet another alternative embodiment of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The best mode for carrying out the invention is presented in terms of its presently preferred embodiment, herein depicted within FIG. 2. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

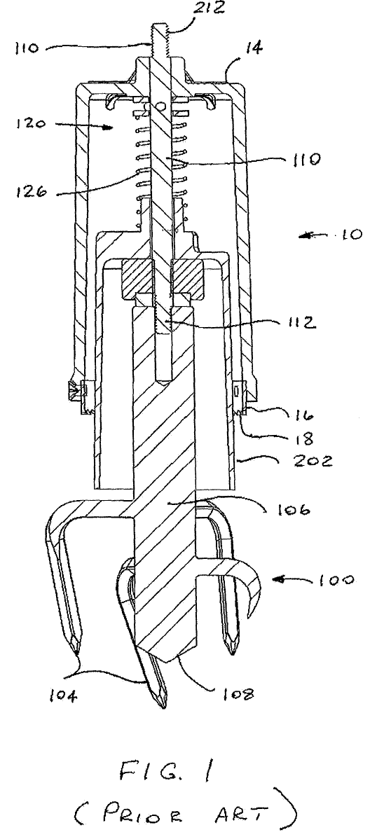

The present invention provides an arrangement for setting variable operating elevation for a hand-held powered tool employed by a user to manipulate an apparatus for at least one of trimming grass from around a head portion of a lawn water sprinkler (not shown) and at least one of tilling, weeding and cultivating a small garden area. Such apparatus is shown in FIG. 1, labeled prior art, and is disclosed in U.S. Utility patent application Ser. No. 11/653,821 filed on Jan. 16, 2007 and entitled “Combination Garden Tiller and Sprinkler Head Grass Trimmer. Disclosure of U.S. Ser. No. 11/653,821 is incorporated into this document by reference thereto. Briefly, the apparatus comprises a combination grass trimmer 10 for trimming grass around the head of a lawn water sprinkler (not shown) and a turbo garden tiller 100. An elongated generally hollow tubular member 12 is provided and is closed at a first end 14 thereof. The first end 14 may also include portion 212 having an external thread. The apparatus further includes at least one of a plurality of serrations 18 and a predetermined number of tine members 104 disposed on a second axially opposed end 16 of the elongated generally hollow member 12.

Now in reference to FIGS. 2, the arrangement of the present invention for setting variable operating elevation of the apparatus includes means, generally designated as 300, attachable to the first closed end 14 of the elongated generally hollow tubular member 12 for setting operating elevation of the at least one of a plurality of serrations 18 and a predetermined number of tine members 104 during manipulation of the apparatus by a powered tool 280 capable of generating rotational motion. There is also means, generally designated as 350, for removing torque applied by the powered tool 280 to at least a portion of the operating elevation setting means 300 during the manipulation of the apparatus.

The operating elevation setting means 300 of the present invention includes at least one elongated drive member 310 having each of a predetermined length and a predetermined cross-sectional shape in a direction transverse to the predetermined length. In accordance with a presently preferred embodiment of the invention, the operating elevation setting means 300 includes a pair of elongated drive members 310. Each of the pair of elongated drive members 310 is provided as a rod like member and has a first end 314 and a second end 316 opposing the first end 314 along the longitudinal axis 312 of the elongated drive members 310. An internal thread 318 is formed axially at each end 314, 316 of each elongated drive member 310. A presently preferred length of each elongated drive member 310 is about eighteen (18) inches, although it is within the scope of the present invention to provide elongated drive members 310 in other length depending on a particular application as well as to provide one elongated drive member 310 having a different length than the other elongated drive member 310. The presently preferred material of the elongated drive member 310 is metal, although other materials are also within the scope of the present invention.

The operating elevation setting means 300 further includes a pair of elongated connecting members 320, each having an external thread 322 and at least a pair of spacers 324 having a washer-like shape. The presently preferred material of the elongated connecting members 320 is metal, although other materials are also within the scope of the present invention.

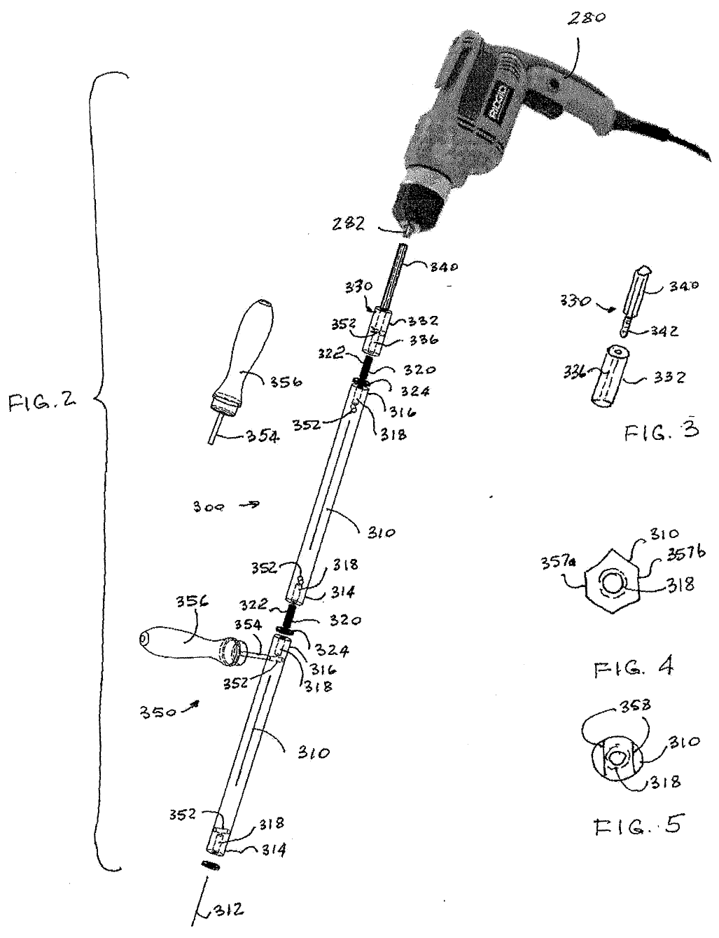

The final essential element of the operating elevation setting means 300 is a drive shaft 330. The drive shaft 330 has a first portion 332 thereof adapted with the internal threaded aperture or bore 336 and has a second axially opposed portion 340 thereof having each of a predetermined length and a predetermined cross-sectional shape in a direction transverse to the predetermined length and which is adapted for caging the second portion 340 by grip jaws 282 of such powered tool 280. Preferably, such predetermined cross-sectional shape is a hexagon. The presently preferred length of the drive shaft 330 is about two (2) inches. The presently preferred material of the drive shaft 330 is metal, although other materials are also within the scope of the present invention. While the second portion 340 may be provided independently from the first portion 332 and joined thereto by way of an externally threaded end 342 in the second portion 340, as best shown in FIG. 3, the present invention contemplates that the first portion 332 and the second portion 340 are formed integral with each other.

In operation, the user can set the operating elevation of the apparatus in a number of different ways. If the user prefers to position the powered tool 280 in close proximity to the ground and bend down to manipulate the apparatus, the user can simply screw the first portion 332 of the drive shaft 330 onto the threaded portion 212. It will be appreciated that the internal thread 336 is formed complimentary to the external thread of the portion 212. If the user prefers to trim grass or work on a garden area by manipulating the apparatus in a generally upright position, the user may simply screw on one end, for example the first end 314, of the elongated drive member 310 to the threaded portion 212, screw the connector 320 into the opposed second end 316 of the elongated drive member 310 so that such connector 320 extends, preferably half way, from such second end 316, screw the first end 314 of the second elongated drive member 310 onto the extending portion of the connector 320, screw a second connector 320 into the second end 316 of the second elongated drive member 310 in a manner substantially identical to threadable insertion of the first connector 320, screw the drive shaft 330 onto the extending portion of the second connector 320 and grip the second end 336 by grip jaws 282 of such powered tool 280.

If the user prefers to manipulate the apparatus at a length which is mediate the length achieved either with the drive shaft 330 or the pair of the elongated drive members 310, the user can simply join one of such pair of elongated drive members 310 to the drive shaft 330 with one connector 320 or directly to the threaded portion 212.

Thus, the user can manipulate the apparatus at three different heights, although the present invention contemplates that additional elongated drive members 310 may be employed to increase incremental settings of the operating length.

It has been found that joining the elongated members 310 with threaded connectors 320 provides rigidity required during manipulation of the apparatus 10, particularly at maximum operating length, as well minimizes manufacturing costs. However, it has been also found that such threaded connections are subject to increased torque condition caused by the rotation of the powered tool 280. This increased torque onto the threaded connections substantially hinders the ability of the user to detach the elongated drive members 310 from each other. Thus, it has been found necessary to provide the means 350 for removing torque applied by such powered tool 280 to at least a portion of the operating elevation setting arrangement during manipulation of the apparatus.

Now in further reference to FIG. 2, such torque removing means 350, constructed in accordance with a presently preferred embodiment of the invention, includes an aperture 352 formed through the at least one elongated drive member 310 in the direction transverse to the predetermined length thereof. There is also an elongated pin 354 that has at least one end thereof sized for insertion into the aperture 352. In operation, to remove the effects of torque, the user simply inserts the elongated pin 354 into the aperture 352 and rotates the elongated pin 354 in a direction which is opposite to the rotating direction of the powered tool 280. To facilitate rotation of the pin 354, a grip 356 is disposed on and secured to the second end of the elongated pin 354.

It has been found advantageous to provide aperture 352 at each end of the elongated drive member 310 as well as in the first portion 332 of the drive member 330 and additionally provide a second elongated pin 354 to improve the leverage of the user attempting to detach the elongated drive members 310 from each other and/or from the drive shaft 330.

The present invention contemplates alternative embodiments of the torque removing means 350. In one alternative embodiment, the elongated pin 354 may be one of secured to and formed integral with the at least one elongated rod like member 310 in the direction transverse to the predetermined length thereof and may be further provided with a grip 356.

In accordance with another alternative embodiment, shown in FIG. 4, the predetermined cross-sectional shape of the at least one elongated rod like member 310 has at least a pair of spaced apart planar surface, referenced with numerals 357a and 357b portions disposed substantially parallel to each other. For example, such predetermined cross-sectional shape may be a hexagon, or a square to facilitate employment of conventional wrenches (not shown).

In yet another alternative embodiment, shown in FIG. 5, the torque removing means 350 may include a pair of spaced apart planar surface portions 358 disposed substantially parallel to each other at least one end of the elongated drive member 310.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with an apparatus for at least one of trimming grass from around a head portion of a lawn water sprinkler and at least one of tilling, weeding and cultivating a small garden area, said apparatus having an elongated generally hollow tubular member closed at a first end thereof and at least one of a plurality of serrations and a predetermined number of tine members disposed at least one of on and adjacent to a second axially opposed end of said elongated generally hollow member, means attachable to said first closed end of said elongated generally hollow tubular member for setting operating elevation for a hand-held powered tool capable of generating rotational motion for manipulation of said apparatus and means for removing torque applied by said powered tool to at least a portion of said operating elevation setting means during said manipulation of said apparatus.

2. The apparatus, according to claim 1, wherein said apparatus includes an externally threaded portion extending axially and outwardly from said first closed end of said elongated generally hollow tubular member and wherein said operating elevation setting means includes:
(a) at least one elongated rod like member having each of a predetermined length and a predetermined cross-sectional shape in a direction transverse to said predetermined length; and
(b) a threaded portion disposed in at least one end of said at least one elongated rod like member coaxially with a longitudinal axis thereof.

3. The apparatus, according to claim 2, wherein said torque removing means includes:
(a) an aperture formed through said at least one elongated rod like member in said direction transverse to said predetermined length thereof; and
(b) an elongated pin having at least one end thereof sized for insertion into said aperture.

4. The apparatus, according to claim 3, wherein said torque removing means further includes a grip disposed on and secured to an opposed second end of said elongated pin.

5. The apparatus, according to claim 2, wherein said torque removing means includes at least one elongated pin at least one of secured to and formed integral with said at least one elongated rod like member in said direction transverse to said predetermined length thereof.

6. The apparatus, according to claim 5, wherein said torque removing means further includes a grip secured to a free end of said at least one elongated pin.

7. The apparatus, according to claim 2, wherein said torque removing means includes said predetermined cross-sectional shape of said at least one elongated rod like member having at least a pair of spaced apart planar surface portions disposed substantially parallel to each other.

8. The apparatus, according to claim 2, wherein said torque removing means includes a pair of spaced apart planar surface portions disposed substantially parallel to each other at one end of said at least one elongated rod like member.

9. The apparatus, according to claim 1, wherein said apparatus includes an externally threaded portion extending axially and outwardly from said first closed end of said elongated generally hollow member and wherein said operating elevation setting means includes:
(a) a predetermined plurality of first elongated rod like members, each of said predetermined plurality of first elongated rod like members having a first threaded portion disposed in a first end of said each first elongated rod like member coaxially with a longitudinal axis thereof and a second threaded portion disposed in an opposed second end of said each first elongated rod like member coaxially with said longitudinal axis thereof;
(b) a predetermined plurality of second elongated members, each of said predetermined plurality of second elongated rod like members having a thread disposed on an exterior surface thereof; and
(c) a third elongated member having each of a hexagonal cross-sectional shape in a direction transverse to a longitudinal axis thereof and an externally threaded end.

10. The apparatus, according to claim 9, wherein said torque removing means includes:
(a) an aperture formed through said at least one first elongated rod like member in a direction transverse to said longitudinal axis; and
(b) at least one elongated pin having at least one end thereof sized for insertion into said aperture.

11. An apparatus for at least one of trimming grass from around a head portion of a lawn water sprinkler and at least one of tilling, weeding and cultivating a small garden area, said apparatus comprising:
(a) an elongated generally hollow tubular member closed at a first end thereof, said elongated tubular member having each of a predetermined length and a predetermined diameter;
(b) a plurality of serrations formed on a second axially opposed end of said elongated generally hollow tubular member for cutting grass disposed around such head portion of such lawn water sprinkler;
(c) an elongated generally hollow housing member at least partially disposed for reciprocal movement within said elongated generally hollow tubular member, said elongated generally hollow housing member being open at a first end thereof and having each of a predetermined length and a predetermined cross-sectional shape in a direction transverse to said predetermined length;
(d) a plate like means disposed at a second end of said axially opposed second end of said elongated generally hollow housing member for closing said second end of said elongated generally hollow housing member and having an outer periphery thereof engageable with an inner surface of said elongated generally hollow tubular member for providing a first portion of a guide means during said reciprocal movement;
(e) a second portion of said guide means disposed around an outer periphery of said elongated generally hollow housing member intermediate each end thereof and having an outer periphery engageable with said inner surface of said elongated generally hollow tubular member for providing a first portion of said guide means during said reciprocal movement;
(f) a first elongated rod like member having each of a predetermined length and a predetermined cross-sectional shape in a direction transverse to said predetermined length;
(g) a predetermined number of tine members secured to an outer surface of said first elongated rod like member adjacent a first end thereof for penetrating a ground surface to said at least one of till, weed and cultivate a small garden area;
(h) a second elongated rod like member engageable at a first end thereof with a second axially opposed end of said first elongated rod like member;
(i) a biasing means disposed over said second elongated rod like member and caged between a pair of plate like members for absorbing shock during use of said apparatus;
(j) means engageable with one of said closed first end of said elongated generally hollow tubular member and said second end of said second elongated rod like member for setting operating elevation for a hand-held powered tool capable of generating rotational motion for manipulation of said apparatus; and
(k) means for removing torque applied by such powered tool to at least a portion of said operating elevation setting means during said manipulation of said apparatus.

12. The apparatus, according to claim 11, wherein said operating elevation setting means includes:
(a) a pair of elongated rod like members, each of said pair of elongated rod like members having each of a longitudinal axis and an internal thread formed axially at each end thereof;
(b) a pair of externally threaded elongated connectors; and
(c) a unitary drive shaft having a first end thereof adapted with said internal thread and having a second axially opposed end thereof having each of a predetermined size and a predetermined cross-sectional shape in a direction transverse to said longitudinal axis adapted for caging said second end by grip jaws of such powered tool.

13. The apparatus, according to claim 12, wherein said torque removing means includes:
(a) a first aperture formed through said each of said pair of elongated rod like members adjacent to and spaced from a respective end thereof in said direction transverse to said longitudinal axis;
(b) a second aperture formed through said drive shaft in a direction transverse to said longitudinal axis; and
(c) at least one elongated grip having each of a predetermined length, a predetermined cross-sectional shape in a direction transverse to said predetermined length of said grip and one end thereof sized for insertion into any one of said first and second apertures.

14. An apparatus for at least one of trimming grass from around a head portion of a lawn water sprinkler and at least one of tilling, weeding and cultivating a small garden area, said apparatus comprising:
(a) an elongated generally hollow tubular member closed at a first end thereof, said elongated tubular member having each of a predetermined length and a predetermined diameter;
(b) a plurality of serrations formed on a second axially opposed end of said elongated generally hollow tubular member for cutting grass disposed around such head portion of such lawn water sprinkler;
(c) an elongated generally hollow housing member at least partially disposed for reciprocal movement within said elongated generally hollow tubular member, said elongated generally hollow housing member being open at a first end thereof and having each of a predetermined length and a predetermined cross-sectional shape in a direction transverse to said predetermined length;
(d) a plate like means disposed at a second end of said axially opposed second end of said elongated generally hollow housing member for closing said second end of said elongated generally hollow housing member and having an outer periphery thereof engageable with an inner surface of said elongated generally hollow tubular member for providing a first portion of a guide means during said reciprocal movement;
(e) a second portion of said guide means disposed around an outer periphery of said elongated generally hollow housing member intermediate each end thereof and having an outer periphery engageable with said inner surface of said elongated generally hollow tubular member for providing a first portion of said guide means during said reciprocal movement;
(f) a first elongated rod like member having each of a first predetermined length and a first predetermined cross-sectional shape in a direction transverse to said first predetermined length;
(g) a predetermined number of tine members secured to an outer surface of said first elongated rod like member adjacent a first end thereof for penetrating a ground surface to said at least one of till, weed and cultivate a small garden area;
(h) a second elongated rod like member engageable at a first end thereof with a second axially opposed end of said first elongated rod like member, said second elongated rod like member having each of a second predetermined length and a second predetermined cross-sectional shape in a direction transverse to said second predetermined length;
(i) a biasing means disposed over said second elongated rod like member and caged between a pair of plate like members for absorbing shock during use of said apparatus;
(j) at least one third elongated rod like member engageable at a first end thereof with a second axially opposed end of said elongated generally hollow tubular member and engageable at an opposed second end thereof with a powered tool capable of generating a rotational motion, said at least one third elongated rod like member having each of a third predetermined length and a third predetermined cross-sectional shape in a direction transverse to said third predetermined length;
(k) at least one aperture formed through said at least one third elongated rod like member in said direction transverse to said third predetermined length; and
(l) an elongated pin having at least one end thereof sized for insertion into said at least one aperture.
